(19) United States
(12) Patent Application Publication
(10) Pub. No.: US 2022/0111430 A1
(43) Pub. Date: Apr. 14, 2022

(54) METHOD FOR STACKING PUNCHED LAMINATION ELEMENTS TO FORM LAMINATION STACKS

(71) Applicant: voestalpine Stahl GmbH, Linz (AT)

(72) Inventor: Ronald FLUCH, Linz (AT)

(21) Appl. No.: 17/556,980

(22) Filed: Dec. 20, 2021

Related U.S. Application Data
(63) Continuation-in-part of application No. 17/609,736.

(30) Foreign Application Priority Data
May 8, 2019 (EP) 19173401.1

(51) Int. Cl. B21D 22/02; B32B 15/01

(52) U.S. Cl. CPC B21D 22/02; B32B 15/011

(57) ABSTRACT

A method for stamping and stacking sheet metal parts to form lamination stacks is disclosed. In order to facilitate the separation of joined sheet metal parts into lamination stacks, a second stamping-out of at least one second sheet metal part is performed in a step preceding the first stamping-out, as well as a pushing-back of the separating element into a region of the electrical steel strip from which the second sheet metal part has been stamped and a pushing-out of the separating element from the electrical steel strip with the first stamping-out.

The invention relates to a method for stamping and stacking sheet metal parts to form lamination stacks, comprising the following steps: a first stamping-out of first sheet metal parts from an electrical steel strip, which has a hardenable adhesive layer, in particular a hot-hardening hot-melt adhesive varnish layer, on at least one of its flat sides, a subsequent stacking of the first sheet metal parts, and a joining, in particular integral joining, of the stacked first sheet metal parts, wherein the method has a scheme for facilitating the separation of the joined first sheet metal parts into lamination stacks, which scheme includes a stacking of at least one separating element with the first sheet metal parts.

### BACKGROUND

The provision of a separating element between first sheet metal parts, which are stacked in a shaft following a last stamping stage of a progressive stamping tool, is known from the prior art (WO2017/060483A1). This separating element facilitates a separation of the integrally joined sheet metal parts into lamination stacks, for example by means of a non-stick coated surface, which reduces the adhesion to a hardening polymer adhesive layer of an adjacent first sheet metal part. Such separating elements are introduced beneath the electrical steel strip in the last stamping stage for the stamping-out and by means of the stamping-out of a first sheet metal part, are pushed into the shaft to be stacked with the other first sheet metal parts. The introduction of the separating element beneath the electrical steel strip disadvantageously requires a comparatively precise positioning of the separating element so that the separating element is not also stamped, which among other things, can cause damage to the progressive stamping tool.

### DISCLOSURE OF THE INVENTION

The object of the invention, therefore, is to modify a method of the type explained at the beginning in such a way that despite the use of a separating element that is stacked together with the first sheet metal parts, it is possible to ensure a high degree of stability.

If the scheme for facilitating the separation of the joined first sheet metal parts into lamination stacks includes the step of a second stamping-out of at least one second sheet metal part in a step preceding the first stamping-out, then the electrical steel strip can be simply included in the scheme for facilitating the separation of the joined first sheet metal parts into lamination stacks. In other words, by means of the second stamping-out, the electrical steel strip has a cut-out region, which can constitute a receptacle in the electrical steel strip.

If in addition, a pushing-back (“push back”) of the separating element into a region of the electrical steel strip from which the second sheet metal part has been stamped takes place, then the separating element can be joined to the electrical steel strip and can also be supplied to the first stamping-out together with the electrical steel strip.

This results in the fact that the separating element is supplied to the method step of the stacking in the same way as the first lamination elements. It is therefore possible to avoid complicated schemes in the last stamping stage for providing separating elements between the sheet metal parts—a pushing-out of the separating element from the electrical steel strip with the first stamping-out is sufficient for this purpose.

In addition, by means of the positioning of the electrical steel strip in the first stamping-out, a reproducible accompanying alignment of the separating element relative to the stamping stage necessarily also takes place, which reliably prevents any damage thereto. By contrast with the prior art, therefore, the method according to the invention can have a particularly high degree of stability.

For example, a hardenable adhesive layer can be based on polyvinyl butyral, polyamides, polyamide, polyester, modified polyamides, or epoxy resin. Preferably, an in particular hot-hardening backlack is used as an adhesive layer. Hardenable polymer adhesive layers have proven to be advantageous.

If the scheme includes the step of a deactivation, hardening, and/or removal of the adhesive layer of the second sheet metal part, then this can allow this second sheet metal part to be used as a separating element. This not only avoids additional separating elements, but also ensures that the pushed-back separating elements always correspond to the dimensions of the open regions on the electrical steel strip. The separating elements can therefore be reproducibly joined to the electrical steel strip—which makes it possible to further extend the service life of the method.

The second sheet metal part can be provided as a separating element in the electrical steel strip in a stable way if it is elongated in at least some areas before the pushing-back. The elongation can be carried out, for example, by means of pulling, pushing, etc.

If the second sheet metal part is joined to a first sheet metal part to form a lamination stack, then this also makes it possible to use the second sheet metal part as part of a lamination stack and thus to further increase the degree of utilization of the electrical steel strip for producing lamination stacks and to reduce waste.

The throughput of the method can remain unchanged by the schemes for facilitating the separation of the joined first sheet metal parts into lamination stacks if the second stamping-out and pushing-back take place in different stages in the stamping and stacking.

It is conceivable for the second stamping-out to take place before a progressive stamping tool, which performs the first stamping-out with a second stamping stage. This also means that no design changes to the progressive stamping tool are required in order to join the separating element to the electrical steel strip.

It is alternatively conceivable for the second stamping-out to be performed by a third stamping stage of a progressive stamping tool, which performs the first stamping-out with a second stamping stage. This requires a design change in the progressive stamping tools that are otherwise known from the prior art, but can further increase the reproducibility of the method due to advantages in the synchronization of the stages to one another.

If the pushing-back takes place in a stage immediately preceding the first stamping-out, then it is also possible for a pushing-out of the separating element from preceding stages of the progressive stamping tool to not occur—which can contribute to the increase in the reliability of the method.

An idling of preceding stamping stages in the progressive stamping tool can be avoided if the second stamping-out takes place in a stage immediately preceding the pushing-back. Among other things, this reduces the risk of damage to its stamp or to the die that cooperates therewith.

The reliability of the method can be further increased if before or during the second stamping-out, at least one pilot hole is punched into the electrical steel strip and during the pushing-back, the separating element and the electrical steel strip are positioned relative to each other with the aid of the pilot hole.

The electrical steel strip can be prepared for the pushing-back in a particularly advantageous way if in its outer dimensions, the second sheet metal part is stamped out to be smaller than the first sheet metal part.

Preferably, the second sheet metal part is stamped out to be at most 2 mm smaller.

The separating element can be accommodated in the electrical steel strip in a stable way if a snug fit is embodied between the separating element and the electrical steel strip.

This snug fit can be embodied in a particularly reproducible way if the separating element and/or the electrical steel strip have projections at which the snug fit is produced.

For example, the separation of the interconnected first sheet metal parts into lamination stacks is facilitated in that the separating element is embodied to reduce the adhesion to an adjacent first sheet metal part.

Preferably, a pusher pushes the separating element back into the electrical steel strip when a counter holder is resting against the electrical steel strip and separating element, the counter holder being positioned opposite from the pusher on the electrical steel strip. It is thus possible, for example, to avoid an unwanted waviness in the electrical steel strip—which can negatively affect the reproducibility of the method.

For example, the counter holder rests against the electrical steel strip so that it completely surrounds the region of the electrical steel strip from which the second sheet metal part has been stamped in order to ensure that the separating element is connected to the electrical steel strip in a stable way and can be processed by the progressive stamping tool.

A projection of the separating element from the electrical steel strip on the upper flat side can be avoided if the counter holder resting against the electrical steel strip comes to rest against the separating element only at the end of the pushing-back of the separating element.

An improved, uninterrupted travel of the strip can be achieved if, during the pushing-back of the separating element, the electrical steel strip is straightened in order to thus improve the evenness of the stamped electrical steel strip. Preferably, the straightening is a flattening.

This can be further improved if the pushed-back separating element does not protrude from the two flat sides of the electrical steel strip.

Preferably, the electrical steel strip is deformed and as a result, a fit is produced on the electrical steel strip for the snug fit between the separating element and the electrical steel strip. This measure is also comparatively easy to achieve in the method.

For example, the fit is produced in that the electrical steel strip is deformed during the stamping-out of the second sheet metal part and/or during the pushing-back of the separating element. To accomplish this, it is conceivable for this deforming step to be carried out with the aid of a die during the stamping-out. This deformation can also take place during the pushing-back of the separating element, for example with the aid of a counter holder on the upper tool that pushes against the electrical steel strip, for example.

For example, the electrical steel strip can be at least partially elongated in order to produce the fit. This can take place by means of a projection in the counter holder, which functions like a pusher tool during the pushing-back of the separating element, which does not negatively affect the cycle time in the method. It is thus possible to achieve a reproducible option for reducing the size of the region on the electrical steel strip from which the second sheet metal part has been stamped—which ensures a stable snug fit with the pushed-back separating element.

It is also conceivable to produce a fit in that a stamping burr that is produced during the second stamping-out is at least partially pressed flat in order to produce the fit. This also makes it possible to reduce the size of the region of the electrical steel strip from which the second sheet metal part has been stamped—and thus to enable a snug fit with the pushed-back separating element.

During the pushing-out of the separating element, the outer contour of the stamping tool presses against the projection or projections of the electrical steel strip or separating element in order to be able to ensure a chip-free pushing-out of the separating element. For this purpose, the outer contour can rest against and extend across the projection or projections of the electrical steel strip or separating element.

In particular, the method according to the invention can be used for producing lamination stacks for electrical machines.

Lamination stacks can be produced in a particularly reproducible way if the hardenable adhesive layer is epoxy resin-based, with a dicyandiamide-based hardener. Preferably, the hardenable adhesive layer is a bisphenol-based epoxy resin system with this hardener. Preferably, the hardenable adhesive layer also contains a metal carbonate, metal sulfate, metal sulfide, metal silicate, metal phosphate, or any mix of a plurality of these as a filler.

### BRIEF DESCRIPTION OF THE DRAWINGS

In the figures, the subject of the invention is shown in greater detail by way example based on several embodiment variants. In the drawings:

FIG. 1 shows a partially cut-away side view of a device for carrying out the method according to a first exemplary embodiment.

FIG. 2a shows a top view of the electrical steel strip in the device shown in FIG. 1.

FIG. 2b shows a detail view of FIG. 2a.

FIG. 3 shows a side view of a device for carrying out the method according to a second exemplary embodiment.

FIG. 4 shows an enlarged view of the device according to FIG. 1 during the pushing-back of a separating element.

FIGS. 4a and 4b show detail views from FIG. 4.

FIG. 5 shows an enlarged view of the device according to FIG. 1 at the end of the pushing-back of the separating element.

FIG. 6 shows a top view of a snug fit alternative to the one in FIG. 2a between the electrical steel strip and separating element.

### DETAILED DESCRIPTION OF THE PREFERRED EMBODIMENTS

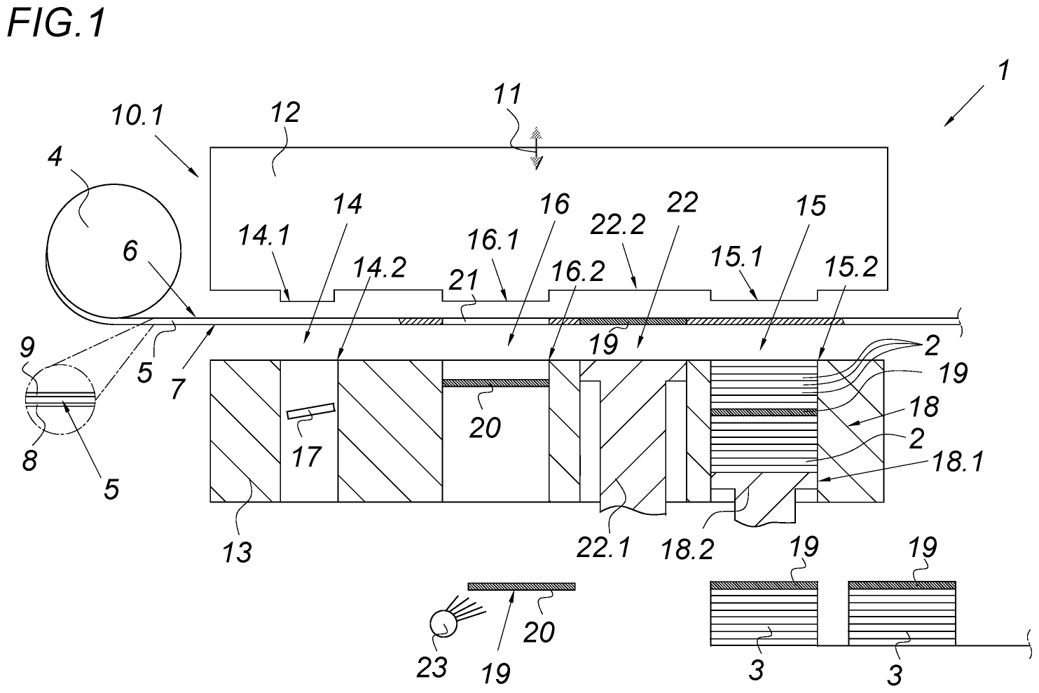

FIG. 1 schematically depicts a first exemplary embodiment of a device 1 for carrying out the stamping and stacking method according to the invention. This device 1 is used for stacking stamped-out first sheet metal parts 2 to form lamination stacks 3. To accomplish this, an electrical steel strip 5 is unwound from a coil 4, which electrical steel strip 5 has a hardenable polymer adhesive layer 8, 9, namely a hot-melt adhesive layer such as a hot-hardenable backlack, covering the entirety of one or both of its flat sides 6, 7—which adhesive layer 8, 9 can be seen, for example, in the enlarged detail in FIG. 1.

A thermosetting or hot-hardening hot-melt adhesive varnish or hot-melt adhesive layer is also known by the term “backlack.” For example, the hot-melt adhesive varnish can be based on an epoxy resin. Preferably, the hot-melt adhesive varnish is a bisphenol-based epoxy resin system with a for example dicyandiamide-based hardener. In particular, the above-mentioned hot-melt adhesive varnish can be a bisphenol-A/epichlorohydrin resin system with dicyanamide as a hardener. This two-stage hardening epoxy resin system is in the B state on the electrical steel strip. As a result, the partially cross-linked hot-melt adhesive varnish is still reactive. When heat is supplied, the hot-melt adhesive varnish in the B state reacts further and can thus be transformed into the C state, which is also referred to as baking. Typically, this partially cross-linked hot-melt adhesive varnish layer has a thickness of a few micrometers. Preferably, the hot-melt adhesive varnish contains a metal carbonate, metal sulfate, metal sulfide, metal silicate, metal phosphate, or any mix of a plurality of these as a filler.

With the aid of a progressive stamping tool 10.1, several first sheet metal parts 2 are stamped out and separated from the backlack-coated electrical steel strip 5. Such a stamping-out—generally speaking—can be a cutting-out, cutting-off, notching, lopping, push-out division, etc.

As can also be inferred from FIG. 1, the stamping tool 10, for example a progressive stamping tool 10.1 in this case, performs a cutting with a plurality of strokes 11 in which its upper tool 12 cooperates with its lower tool 13. To accomplish this, the stamping tool 10 has a plurality of stamping stages 14, 15, and 16.

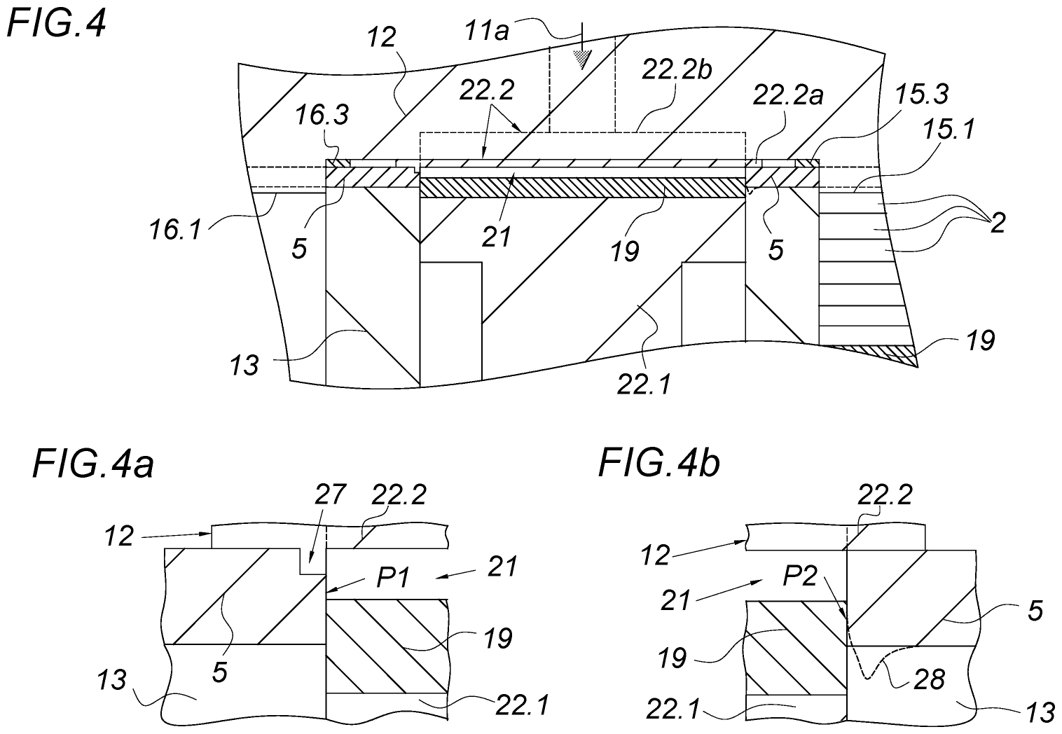

With a blade 14.1 of the preprocessing stamping stage 14 on the upper tool 11, the electrical steel strip 5 is preprocessed for a stamping-out, after which a second blade 15.1 of the second and also last stamping stage 15 on the upper tool 11 stamps out and thus separates first sheet metal parts 2 from the electrical steel strip 5. To accomplish this, the blades 14.1, 15.1, and 16.1 cooperate with the respective dies 14.2, 15.2, and 16.2 of the stamping stages 14, 15, and 16 on the lower tool 13. As is known, the respective stamping stages 14, 15, 16 also have a stripper on the upper tool 11 with which the electrical steel strip 5 can be held down during the stamping and/or can also be stripped from the relevant blade 14.1, 15.1, 16.1. For example, the strippers 15.3, 16.3 can be seen in FIG. 4.

Such a progressive cutting can be identified in FIG. 1 among other things from the fact that in the preprocessing stamping, a part 17 is separated from the electrical steel strip 5 in order to prepare the electrical steel strip 5 for the stamping-out of the first sheet metal part 2.

The pressure of the upper tool 11 or more precisely the blade 15.1 moves the first sheet metal parts 2 that have been stamped out with the aid of the stamping stage 15 into a stacking device 18 and stacks them therein. In this case, the electrical steel strip 5 is held down by a stripper 15.3 on the upper tool 11.

For this purpose, the stacking device 18 has a shaft 18.1 and a counter holder 18.2 in the lower tool 13. This counter holder 18.2 in the lower tool 13 slows down the first sheet metal parts 2, as a result of which these sheet metal parts 2 are physically and/or chemically joined due to the pressure of the upper tool 11 and with the aid of the adhesive layer 8, 9 that is present between the sheet metal parts 2. In general, it should be noted that the stacking device 18 can be actively heated in order to thus integrally join the first sheet metal parts 2 in the shaft 18.1. In addition, the first lamination stacks 3 can undergo further hardening steps that are not shown in order to produce an integral connection between the first sheet metal parts 2.

The stamped sheet metal parts 2 are glued to one another to form a lamination stack 3 and are thus stacked. A stamping of sheet metal parts 2 and a stacking of these sheet metal parts 2 to form lamination stacks 3 is also often referred to as “stamping and stacking.” Alternative to gluing, other joining methods are also known for the stacking, for example riveting, clamping, clinching with knobs, or welding with a laser.

It is also possible for the stacking device 18 to be rotated in order, for example, to produce segmented lamination stacks 3 from layers with a plurality of first sheet metal parts 2 that are positioned next to and on top of one another—which is also not shown.

For example, the lamination stacks 3 are used as stators, rotors, etc. in electrical machines.

In order to be able to separate the lamination stacks 3 exiting the stacking device 18 from one another more easily, at least one separating element 19 is stacked together with the first sheet metal parts 2. To accomplish this, the separating element 19 is embodied to reduce the adhesion to the adhesive layer 8, 9 of at least one first sheet metal part 2 adjacent thereto. This creates a reduced adhesive force between the first sheet metal parts 2 of the adjacent lamination stacks 3, which facilitates the separation of the joined first sheet metal parts 2 into lamination stacks 3.

According to the invention, the separating element 19 is introduced into the stacking device 18 with the aid of the electrical steel strip 5. For this purpose, a second stamping-out with the stamping stage 16 is first carried out through a cooperation of a blade 16.1 and a die 16.2, which cuts a second sheet metal part 20 out from the electrical steel strip 5. This produces a cut-out region 21 in the electrical steel strip 5. In this cooperation, the electrical steel strip 5, as shown in FIG. 4, is held down by a stripper 16.3 on the upper tool 11.

This cut-out region 21 is used to accommodate the separating element 19 in the electrical steel strip 5—as shown in FIG. 1 and in enlarged form in FIG. 4, the separating element 19 is conveyed to the electrical steel strip 5 on the underside or more precisely on the lower flat side 17, namely in that the stamping tool 10 has a stage 22 for pushing back mechanisms. These mechanisms are embodied as a moving pusher 22.1 in the lower tool 13 and as a for example fixed counter holder 22.2 in the upper tool 12. The counter holder 22.2 is positioned opposite from the pusher 22.1 on the electrical steel strip 5.

With this stage 22, the separating element 19 is pushed back into a region 21 of the electrical steel strip 5 from which the second sheet metal part 20 has been stamped. As a result, the separating element 19 is thus conveyed together with the electrical steel strip 5 in the stamping tool 10. Other mechanisms for pushing back are conceivable, but not shown.

As is clear from FIG. 4, during the pushing-back of the separating element 19, the counter holder 22.2 rests against the electrical steel strip 5, the latter occurring during the stamping stroke 11a of the tools. This takes place in that the counter holder 22.2 rests against the electrical steel strip 5 so that it completely surrounds the region 21 of the electrical steel strip 5 from which the second sheet metal part 20 has been stamped. The electrical steel strip 5 is thus held between the counter holder 22.2 and the lower tool 13, the latter occurring at least at the edge of the region 21, thus enabling a precise insertion of the separating element 19, taking into account a slight risk of deformation in the electrical steel strip 5.

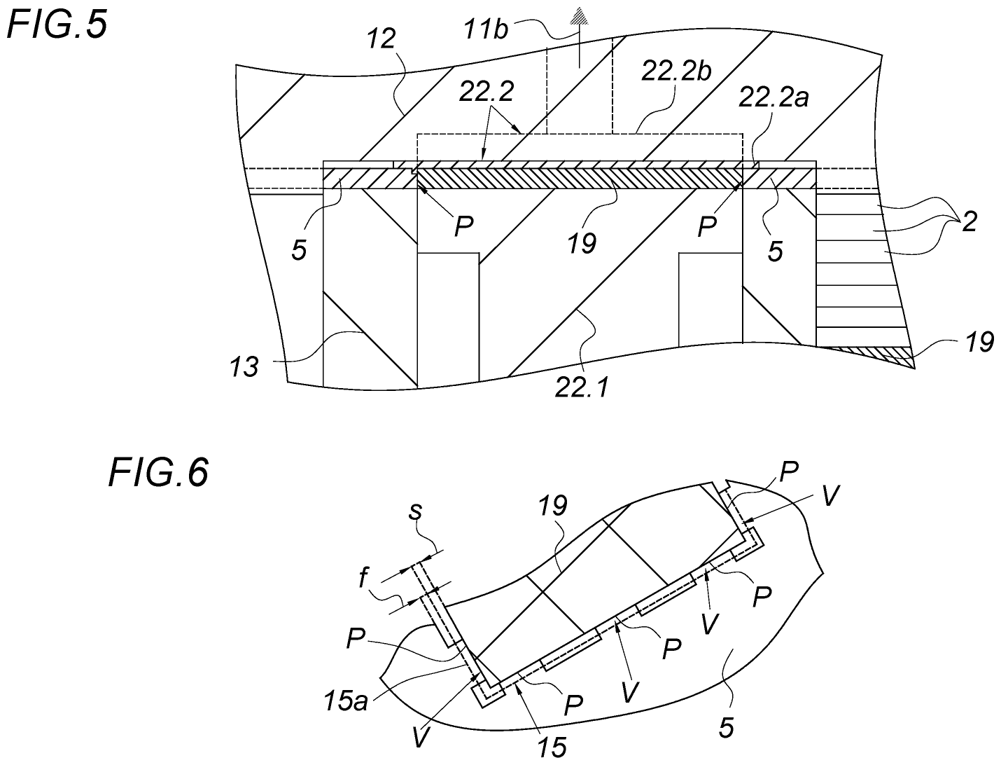

As is clear from FIG. 5, the counter holder 22.2 resting against the electrical steel strip 5 also comes to rest against the separating element 19 only at the end of the pushing-back of the separating element 19. This additionally also ensures that the pushed-back separating element 19 does not protrude from the two flat sides 6, 7 of the electrical steel strip 5.

The counter holder 22.2 can have a plurality of parts, for example a hold-down device 22.2a and a holder 22.2b, which is indicated with dashed lines in FIG. 4. The holder 22.2b is enclosed by the hold-down device 22.2a and during the pushing-back, can cooperate with the pusher 22.1 to hold the separating element 19. For this purpose, the holder 22.2b is connected to a drive device, for example a plunger, so that it can be moved in linear fashion together with the pusher 22.1. For simplicity, the counter holder 22.2 can consist of one part, as shown in FIG. 4.

By means of the stage 22 shown in FIGS. 1, 4, and 5, the electrical steel strip is also straightened, in particular flattened, during the pushing-back of the separating element 19. This ensures that the additional steps in the progressive stamping method can be carried out in a reproducible way despite the additional method steps performed on the electrical steel strip for the pushing-back.

After the stamping stroke 11a, the opening 11b of the tools takes place, after which the separating means 19 provided in the electrical steel strip 5 is advanced to the next stage 15.

In the last stamping stage 15, the separating element 19 is consequently pushed out from the electrical steel strip 5. As a result, the separating element 19 is positioned between the first sheet metal parts 2 in the stacking device 18, which facilitates the separation of the lamination stacks 3 upon departure from the stacking device 18.

It is also clear from FIG. 1 that the polymer adhesive layer 8 on one side of the second sheet metal part 20 has been deactivated by means of a heat source 23. As a result, the second sheet metal part 20 can also be used as a separating element 19—and can be pushed back into the electrical steel strip 5. Other methods for deactivating the polymer adhesive layer 8 are conceivable, for example hardening and/or removal, etc.

Since deactivation occurs on only one side of the second sheet metal part 20, i.e. the adhesive layer 8, the second sheet metal part 20 not only can function as a separating element 19, but also—by means of its second, non-deactivated adhesive layer 9—can be bonded to a lamination stack 3 and thus used along with it. This ensures a high degree of utilization of the electrical steel strip 5.

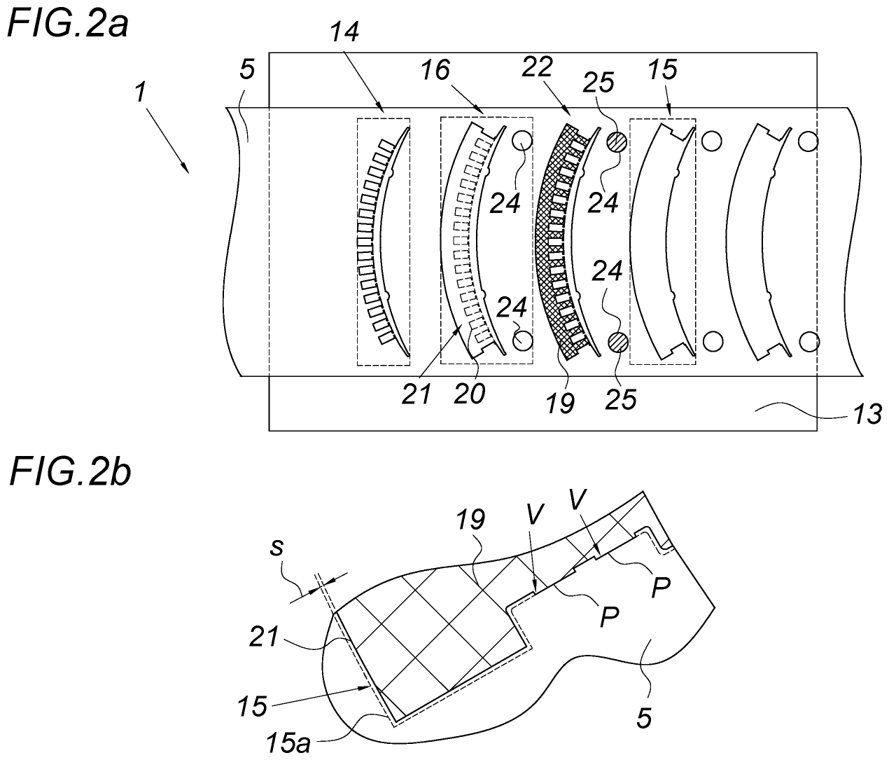

As can be inferred from FIG. 2a, the second stamping-out and pushing-back take place in different stages—namely, the pushing-back takes place in a stage 22 immediately preceding the first stamping-out and the second stamping-out takes place in a stage 22 immediately preceding the pushing-back. In addition, all of the stages 14, 15, 16, and 22 are part of the stamping tool 10.

In addition, during the second stamping-out, two pilot holes 24 are punched into the electrical steel strip—with the third stamping stage 16. The separating element 19 and the electrical steel strip 5 are positioned relative to each other with the aid of these pilot holes 24. For this purpose, two pins 25 on the pusher 22.1 each protrude into a respective pilot hole 24 in the electrical steel strip 5. This ensures a precisely positioned provision of the separating element 19 in the cut-out region 21 of the electrical steel strip 5, which significantly increases the reproducibility of the method.

It is clear from FIG. 2b that the second stamping-out of a second sheet metal part 20 takes place with outer dimensions that are smaller than those of the first sheet metal part 2 by the normal gap s. As a result, the cut-out region 21 is smaller than the outer contour 15a of the second stamping stage 15. Preferably, the normal gap s is two millimeters (mm). It is also clear from FIG. 2b that the separating element 19 has projections V. At these rectangular projections V, a snug fit P with the electrical steel strip 5 is produced, which securely holds the separating element 19 in the electrical steel strip 5. For this purpose, for example the second sheet metal part 20 used as a separating element 19 is elongated in the region of the projections V. But it is also conceivable for there to be a snug fit P in other regions of the separating element 19—which is not shown.

The snug fit P, however, can be achieved with a fit P1, P2 on the electrical steel strip 5. For this purpose, the electrical steel strip 5 is deformed and as a result, a fit P1, P2 is produced on the electrical steel strip 5 for the snug fit P between the separating element 19 and the electrical steel strip 5. As is clear from FIGS. 4, 4a, and 4b, this occurs during the pushing-back of the separating element 19.

For this purpose, the electrical steel strip 5 is at least partially elongated, namely by means of a pusher tool, in order to produce the first fit P1, which is formed by a projection 27 on the counter holder 22.2. This projection 27 pushes the material of the electrical steel strip 5 slightly into the free region 21, which is by itself sufficient to produce a snug fit P for holding the separating element 19 securely against the electrical steel strip 5.

Alternatively or in addition, a second fit P2 can be produced by virtue of the fact that a stamping burr 28, which is possibly produced during the second stamping-out, is pressed flat, as can be seen from FIG. 4b. Here, too, material can be introduced into the free region 21 in order to produce a sufficient snug fit P.

FIG. 6 shows a top view of the projections V on the electrical steel strip 5 and the fits P1 and/or P2 produced therewith that form a snug fit P with the separating element 19. The outer contour 15a of the second stamping stage 15 extends across the tooth-shaped projections V of the electrical steel strip 5. This is clear from the distance t that is present between the bottom of the projection V and the outer contour 15a in FIG. 6. Since as a result of this, during the pushing-out of the separating element 19, the outer contour 15a of the stamping tool 15 presses against the projections V of the electrical steel strip 5, the projections V that are spaced apart from one another are bent and not separated from the electrical steel strip 5, which avoids the generation of chips and/or metal flakes during the pushing-out of the separating element 19. Preferably, the distance of the projections V from one another is at least equal to twice their width.

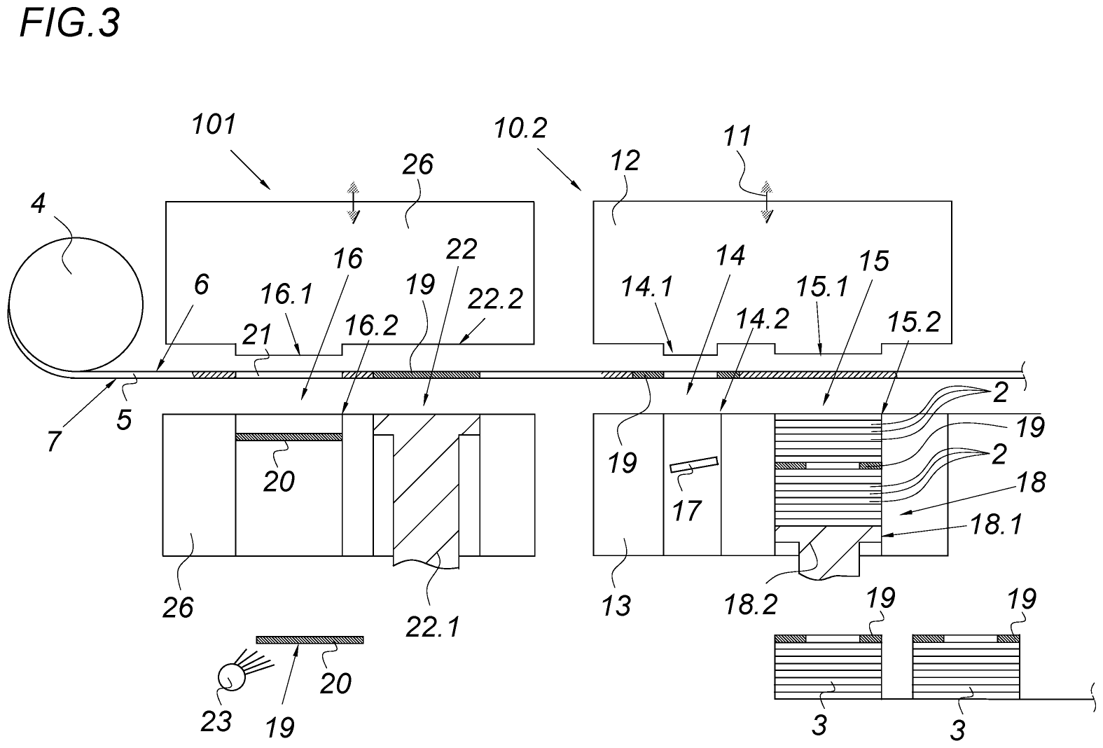

FIG. 3 schematically depicts an alternative device 101 for carrying out the method according to the invention. This second device 101 differs from the first device 1 according to FIG. 1 by means of an additional tool 26, which is provided before a second progressive stamping tool 10.2 for the stamping and stacking. This tool 26, which is provided separately from the second progressive stamping tool 10.2, performs the steps that are performed by the progressive stamping tool 10 according to FIG. 1, namely a second stamping-out and a pushing-back. The second stamping-out and pushing-back therefore take place before the progressive stamping tool 10.2, which performs the first stamping-out with a second stamping stage 16—in addition, the preprocessing stamping according to FIG. 1 is carried out with the aid of stage 14 of the progressive stamping tool 10.2.

Known progressive stamping tools 10.2 can therefore be retrofitted with the tool 26 in order to carry out the method according to the invention.

1. A method for stamping and stacking sheet metal parts to form lamination stacks, comprising the following steps:
performing a first stamping-out of first sheet metal parts from an electrical steel strip, which has a hot-hardening hot-melt adhesive varnish layer on at least one flat side of the electrical steel strip,
subsequently stacking the first sheet metal parts, and
integrally joining the stacked first sheet metal parts,
wherein the method has a scheme for facilitating a separation of the joined first sheet metal parts into lamination stacks, which scheme includes stacking at least one separating element with the first sheet metal parts, and the scheme comprises the following steps:
performing a second stamping-out of at least one second sheet metal part in a step preceding the first stamping-out,
pushing back the at least one separating element into a region of the electrical steel strip from which the second sheet metal part has been stamped, and
pushing out the at least one separating element from the electrical steel strip with the first stamping-out.

2. The method according to claim 1, wherein the scheme includes the following additional step:
deactivating, hardening, and/or removing the adhesive varnish layer of the second sheet metal part and using the second sheet metal part as the at least one separating element.

3. The method according to claim 2, wherein the second sheet metal part is elongated in at least some areas before the pushing back step.

4. The method according to claim 2, wherein the second sheet metal part is joined with one of the first sheet metal parts to form a lamination stack.

5. The method according to claim 1, wherein the second stamping-out and the pushing back step take place in different stages.

6. The method according to claim 1, wherein the second stamping-out takes place before a progressive stamping tool, which performs the first stamping-out with a second stamping stage.

7. The method according to claim 1, wherein the second stamping-out is performed by a third stamping stage of a progressive stamping tool, which performs the first stamping-out with a second stamping stage.

8. The method according to claim 7, wherein the pushing back step takes place in a stage immediately preceding the first stamping-out.

9. The method according to claim 8, wherein the second stamping-out takes place in a stage immediately preceding the pushing back step.

10. The method according to claim 1, wherein before or during the second stamping-out, at least one pilot hole is punched into the electrical steel strip and during the pushing back step, the at least one separating element and the electrical steel strip are positioned relative to each other with the aid of the at least one pilot hole.

11. The method according to claim 1, wherein in its outer dimensions, the second sheet metal part is stamped out to be smaller than the first sheet metal part.

12. The method according to claim 11, wherein the second sheet metal part is stamped out to be at most 2 mm smaller than the first sheet metal part.

13. The method according to claim 1, wherein a snug fit is embodied between the at least one separating element and the electrical steel strip.

14. The method according to claim 13, wherein the at least one separating element and/or the electrical steel strip have projections at which the snug fit is produced.

15. The method according to claim 1, wherein the at least one separating element is embodied to reduce adhesion to an adjacent first sheet metal part in order to thus facilitate the separation of the joined first sheet metal parts into lamination stacks.

16. The method according to claim 1, wherein a pusher pushes the at least one separating element back into the electrical steel strip when a counter holder is resting against the electrical steel strip and the at least one separating element, the counter holder being positioned opposite from the pusher on the electrical steel strip.

17. The method according to claim 16, wherein the counter holder rests against the electrical steel strip so that the counter holder completely surrounds a region of the electrical steel strip from which the second sheet metal part has been stamped.

18. The method according to claim 16, wherein the counter holder resting against the electrical steel strip comes to rest against the at least one separating element only at an end of the pushing back step of the at least one separating element.

19. The method according to claim 1, wherein during the pushing back step of the at least one separating element, the electrical steel strip is flattened.

20. The method according to claim 19, wherein the at least one pushed-back separating element does not protrude from two flat sides of the electrical steel strip.

21. The method according to claim 1, wherein the electrical steel strip is deformed and as a result, a fit is produced on the electrical steel strip for a snug fit between the at least one separating element and the electrical steel strip.

22. The method according to claim 21, wherein the electrical steel strip is deformed during the second stamping-out of the second sheet metal part and/or during the pushing back step of the at least one separating element.

23. The method according to claim 21, wherein the electrical steel strip is at least partially elongated in order to produce the fit.

24. The method according to claim 21, wherein a stamping burr that is produced during the second stamping-out is at least partially pressed flat in order to produce the fit.

25. The method according to claim 1, wherein during the pushing out step of the at least one separating element, an outer contour of a stamping tool presses against a projection or projections of the electrical steel strip or of the at least one separating element.

26. The method according to claim 1, comprising producing lamination stacks for electrical machines.

27. The method according to claim 1, wherein the hardenable adhesive varnish layer is epoxy resin-based, with a dicyandiamide-based hardener.
